(19) United States
(12) Patent Application Publication
(10) Pub. No.: US 2024/0256117 A1
(43) Pub. Date: Aug. 1, 2024

(54) MULTIMODAL SCROLLING SYSTEM

(71) Applicant: Microsoft Technology Licensing, LLC, Redmond, WA (US)

(72) Inventor: Nishith ANAND, Noida (IN)

(21) Appl. No.: 18/565,285

(22) PCT Filed: May 12, 2022
(86) PCT No.: PCT/US2022/028885

§ 371 Date: Nov. 29, 2023

(30) Foreign Application Priority Data
Jun. 17, 2021 (IN) 202111027169

(51) Int. Cl. G06F 3/0485; G06F 3/0482; G06F 3/0488

(52) U.S. Cl. CPC G06F 3/0485; G06F 3/0482; G06F 3/0488; G06F 2203/04808

(57) ABSTRACT

Methods, systems, and computer programs are presented for providing gesture-based multimodal scrolling in a computer user interface. One method includes an operation for causing presentation of a user interface (UI) that presents a list of items. The UI provides a first and a second mode for scrolling through the list. The first mode scrolls through the list of items at a first speed and the second mode scrolls at a second speed, different from the first speed. The method further includes an operation for scrolling in the first mode in response to detecting a first gesture associated with the first mode, while scrolling in the first mode, causing presentation of an option in the UI to change the scrolling speed by switching to the second mode. Further, the method includes scrolling in the second mode in response to detecting a second gesture associated with the second mode.

### TECHNICAL FIELD

The subject matter disclosed herein generally relates to methods, systems, and machine-readable storage media for improving user interfaces in a computing system.

### BACKGROUND

Exploring a long list of items to find a desired item may be a difficult experience if the list is very long, especially when using a small display, such as in a mobile home. Sometimes, a user may facilitate the search by adding values to the search parameters, e.g., adding more words in a search text string. However, sometimes adding search parameters is not possible, such as when looking for a photo in a gallery with a large number of photos.

What is needed are better search options for users in order to accelerate the search for a desired item.

### BRIEF DESCRIPTION OF THE DRAWINGS

Various of the appended drawings merely illustrate example embodiments of the present disclosure and cannot be considered as limiting its scope.

FIG. 1 illustrates a user scrolling through a list of items in a Graphical User Interface (GUI), according to some example embodiments.

FIG. 2 shows a sample architecture for implementing exemplary embodiments.

FIG. 3 is a flowchart of a method for implementing multimodal scrolling, according to some example embodiments.

FIG. 4 is a flowchart of a method for selecting filters by a machine-learning (ML) model, according to some example embodiments.

FIG. 5 illustrates the training and use of a machine-learning model for selecting filters, according to some example embodiments.

FIG. 6 is the flowchart of a method for implementing multimodal scrolling in a photo searching application, according to some example embodiments.

FIG. 7 is a flowchart of a method for providing gesture-based multimodal scrolling in a computer user interface, according to some example embodiments.

FIG. 8 is a block diagram illustrating an example of a machine upon or by which one or more example process embodiments described herein may be implemented or controlled.

### DETAILED DESCRIPTION

Example methods, systems, and computer programs are directed to providing gesture-based multimodal scrolling in a computer user interface. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

A multimodal scrolling method is provided. During normal scrolling (e.g., single-finger scrolling), the UI scrolls a list of items for inspection by the user. If the user changes the scrolling mode (e.g., the user switches to two-finger scrolling), the UI changes behavior and starts scrolling in a second mode, e.g., faster scrolling by going month-to-month as the user scrolls. Additionally, the UI may offer filter options for changing the behavior of the second mode (e.g., scrolling by week or month, scrolling by author, scrolling by subjects identified in photos, etc.).

One general aspect includes a method that includes an operation for causing presentation of a user interface (UI) that presents a list of items. The UI provides a first and a second mode for scrolling through the list. The first mode scrolls through the list of items at a first speed and the second mode scrolls at a second speed, different from the first speed. The method further includes an operation for scrolling in the first mode in response to detecting a first gesture associated with the first mode. while scrolling in the first mode, causing presentation of an option in the UI to change the scrolling speed by switching to the second mode. Further, the method includes scrolling in the second mode in response to detecting a second gesture associated with the second mode.

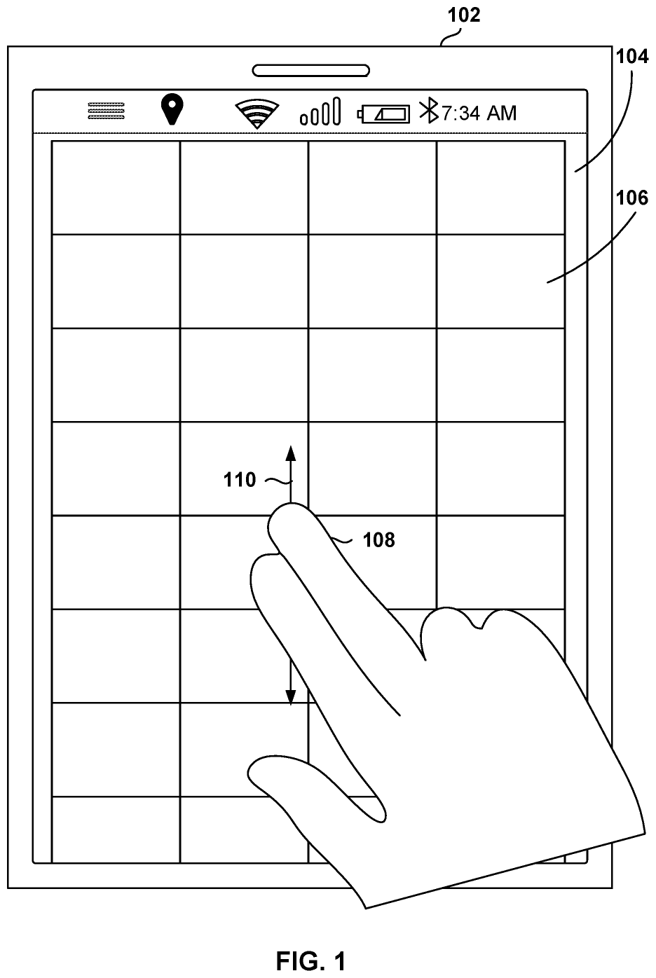

FIG. 1 illustrates a user scrolling through a list of items in a Graphical User Interface (GUI) 104, according to some example embodiments. A user is scrolling through a list of photos 106 in the GUI 104 of a mobile phone 102.

In the illustrated example, the user scrolls down the list by using a single finger scrolling across the display. This mode is referred to herein as first mode, S1 (scroll first mode), or standard mode. However, the user may be searching for a photo that he took six months earlier, so the user has to scroll through a long list of photos 106.

In some example embodiments, the application offers a second mode of scrolling (e.g., scrolling 110 with two fingers 108 touching the display), and the second mode will cause the scrolling of the photo list to scroll one month at a time. The second scroll mode is referred to herein as S2 mode.

For example, if the user scrolls back in time, scrolling in the S2 mode will cause the display to jump to the previous month, then the month before that one, etc. Once the user reaches the desired month, the user may revert back to S1 mode and focus the search on the desired month.

Thus, the application provides at least two modes of scrolling, referred to as hybrid scrolling or multimodal scrolling. Embodiments are described with reference to the S1 mode being a single-finger scrolling (SFS), and the S2 mode being a double-finger scrolling (DFS), but the same principles may be applied to other types of inputs. As used herein, the different modes of scrolling are referred to as different types of gestures.

For example, the S1 or S2 modes may be one of the SFS on a touchscreen, the DFS on the touchscreen, SFS on a mousepad, DFS on the mousepad, wheel scrolling on a mouse, wheel scrolling on a mouse while pressing a keyboard key (e.g., Shift, Control, Windows, Alt, or a combination of keys), different modes of hand gestures in front of a camera, moving a scroll bar with the left button or the right button of a mouse, using an electronic pen on a display, etc. The embodiments described should therefore not be interpreted to be exclusive or limiting, but rather illustrative.

The gestures may be detected based on their configuration. For example, the two-finger scrolled is detected when two separate contact points are made on the touchscreen and both contact points move in the same direction at the same speed. Further, the scrolling gesture may be detected in different directions, such as up and down, side to side, or a combination thereof. Hand gestures in front of a camera may be detected by using image recognition of a location of the hand (or a part of the hand such as one or more fingers) in the captured images, and tracking the location of the hand over time on multiple images.

Some of the examples where users have to scroll through a long list of items include searching for photos on the phone-gallery app, searching for photos or videos on WhatsApp, searching for posts on a social network (e.g., LinkedIn, Facebook), searching for a list of results after a search, searching for a text message in the texting app, searching for contacts in contact list, searching for emails on a folder, scrolling through a spreadsheet, scrolling through a document, etc. In some of the examples, the list may be the result of a search, but in other cases, the list exists in one app and not necessarily resulting from a search.

Further, the different scrolling modes may be selected from a group consisting of up/down, by initial letter of a contact name, by company (e.g., in a contacts list), by date, by week, by month, by year, by sheet on a spreadsheet, by chapter in a document, by section in a document, by page in a document, by section on a newspaper or website, by sender, by recipient, by creator, by people detected in photos, by subject (e.g., emails, school subjects), by account, by client, etc.

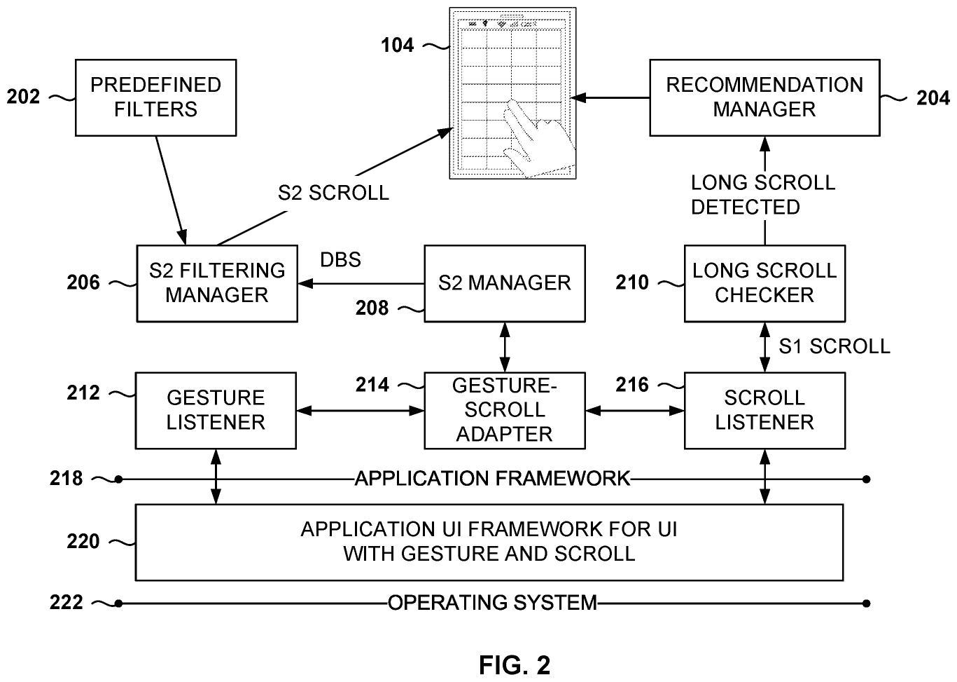

FIG. 2 shows a sample architecture for implementing exemplary embodiments. The S2 may have a default behavior (e.g., scrolling by month), or may have one or more configurable filters associated with the DFS, such as filters based on date, content, people associated with the list, age of the item, etc.

In some example embodiments, the application executing on the device provides an interface to allow the user to configure the filters, such as selecting to scroll by day, week, or month. When the user starts the DFS, the application will select the option configured by the user.

Additionally, filters may be activated “on the fly.” When the S2 mode is detected, the system determines if there are one or more filters that may be configured by the user and show an option to the user to select one of those filters. In other cases, the system uses the default filtering and the filter option is not presented.

The operating system (OS) 222 (e.g., Android, Windows) provides the services for managing the device, including utilities for presenting the GUI 104. An application UI framework 220, on top of OS 222, provides utilities for drawing on the GUI 104 with multimodal scrolling using different gestures. The utilities are provided on an application framework 218 (e.g., Application Programming Interface (API). The applications executing on the device benefit for the multimodal scrolling by accessing application framework 218.

The application framework 218 provides two listeners, which are applications checking user inputs. The gesture listener 212 analyzes user inputs to detect gestures associated with the S2 mode (e.g., DFS). The scroll listener 216 analyzes user inputs to detect the S1 mode (e.g., SFS) provided by the OS or the application.

The gesture scroll adapter 214 interfaces with the gesture listener 212 and the scroll listener 216 to determine if the user is scrolling in S1 or S2 mode (e.g., SFS or DFS).

When the scroll listener 216 detects S1 mode, the long scroll checker 210 determines if the user is performing a long scroll, which is a scroll going through a large number of items. When the long scroll checker 210 determines that there is a long scroll in S1 mode, the recommendation manager 204 presents a message in the GUI 104 to notify the user about the S2 mode of scrolling, so the user can switch to S2 modes and scroll faster. For example, the recommendation manager 204 may present a message, “Long-scroll detected. To advance faster, switch to double-finger swipe to scroll month by month.”

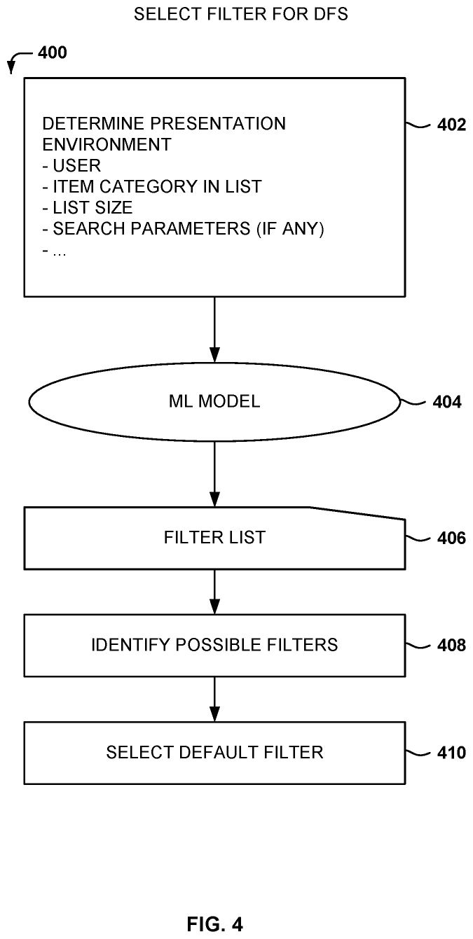

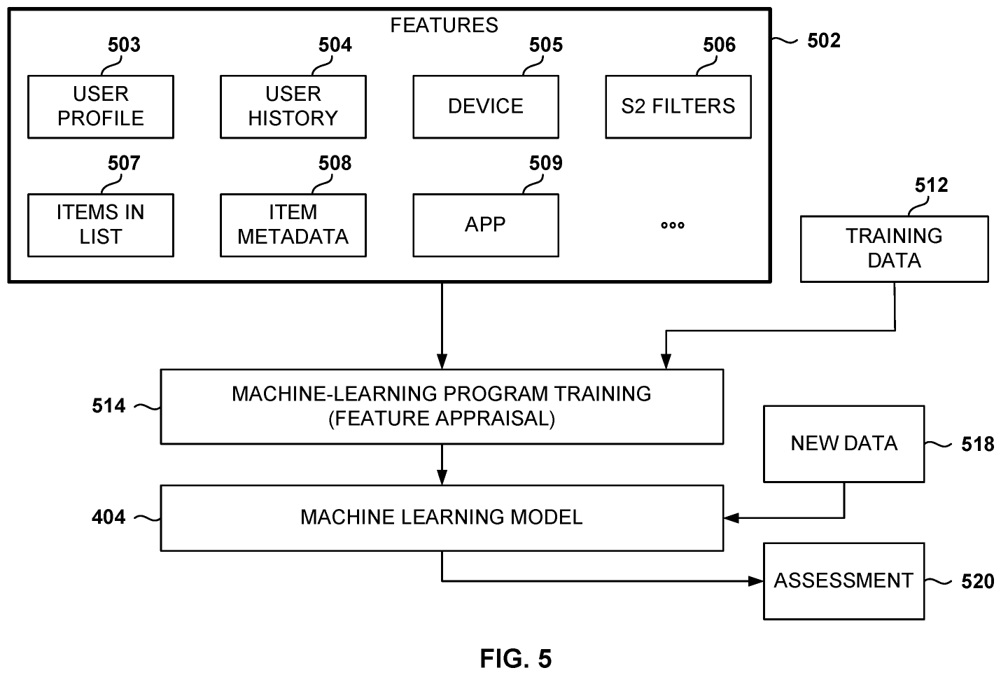

Additionally, the recommendation manager 204 may notify the user that different types of filters are provided when the user switches to S2 mode. The recommendation manager may use heuristics (e.g., rules) to determine the operation of the S2 mode, based on the user, the items being examined, etc. In other example embodiments, the recommendation manager 204 utilizes a machine-learning (ML) model to determine the best mode of operation for S2 (e.g., scroll one week at a time or one month at a time). More details are provided below with reference to FIGS. 4-5 regarding the operation and use of the ML model.

When the gesture scroll adapter 214 detects S2 scrolling (e.g., DFS), the gesture scroll adapter 214 notifies the S2 manager 208 that sets up the appropriate filtering for S2 scrolling, including suggesting one or more filtering options to the user.

The S2 filtering manager 206 sets up the appropriate filter and updates the GUI 104 base on the scrolling input by the user (e.g., scrolling one year at a time). Further, the S2 filtering manager 206 may use predefined filters 202 for use during S2 scrolling, at least until the user selects a different filtering option. When in S2 mode, the GUI 104 will start the scroll according to the filtering selected.

In some example embodiments, the application listing the items on the GUI 104 interacts with the application framework 218 to know when the scrolling mode has changed, and the application will then change scrolling mode based on the notification.

In other example embodiments, the S2 scrolling is transparent to the application listing the items. The S2 manager provides inputs to the application as if normal scrolling was begin used, but the S2 manager creates artificial inputs to simulate faster scrolling. For example, the S2 manager will simulate an S1 scroll long enough to change to the next month of photos, although the user may be doing a short S2 scroll to change months. This way, users can start taking advantage of the benefits of S2 scrolling by updating the OS, without having to wait for each application to be updated to do S2 scrolling.

By accelerating the scrolling operation with the S2 mode, the user gets to the desired item faster, which results in a reduction of computing resource utilization because the computer does not have to process and display a large number of items due to the skipping of many elements on the list that do not have to be displayed. The reduction in computing resources includes fewer operations by the processor, fewer access operations to memory, fewer network traffic (e.g., when the list of items resides in a remote server or a cloud service), and reduce battery consumption due to the faster searching and reduced use of computing resources.

In some example embodiments, the GUI is driven by an application executing in the mobile device. In other example embodiments, the GUI is driven by an application executing in a remote device (e.g., server or cloud service) and the mobile device is used to render the GUI according to instructions originated by the remote device.

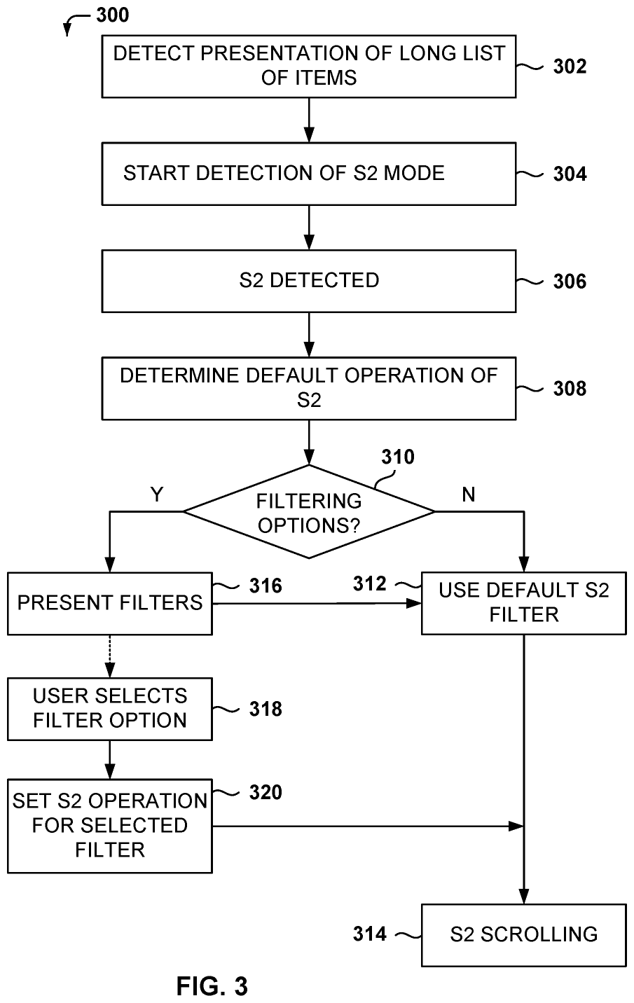

FIG. 3 is flowchart of a method 300 for implementing multimodal scrolling, according to some example embodiments. While the various operations in this flowchart are presented and described sequentially, one of ordinary skill will appreciate that some or all of the operations may be executed in a different order, be combined or omitted, or be executed in parallel.

At operation 302, the system detects the presentation of a language of items, such as showing search results after performing the search, or inspecting a large gallery of photos on a mobile-phone app.

From operation 302, the method 300 flows to operation 304, where the system starts the detection of the S2 mode. At operation 306, the S2 mode is detected (e.g., the user starts scrolling with two fingers).

From operation 306, the method 300 flows to operation 308, where the system determines the default operation for S2 mode (e.g., scrolling by month), and scrolling in S2 mode continues at operation 314.

At operation 310, the system determines if there are other filtering options, besides the default operation, that the user may utilize. If there are no other filtering options, the default S2 filter is used at operation 312.

Further, if there are additional filtering options, the filters are presented at operation 316, as the user continues scrolling in S2 mode. If the user selects one of the filtering options (operation 318), a separate user interface is presented (e.g., a pop-up window) for selecting the filter. For example, the user may be able to select scrolling by week, by month, by sender, by creator, by folder in a file system, etc.

At operation 320, the S2 mode filtering is set according to the user selection and the user continues scrolling (operation 314) using the new filtering option.

FIG. 4 is a flowchart of a method 400 for selecting filters by a machine-learning (ML) model, according to some example embodiments. While the various operations in this flowchart are presented and described sequentially, one of ordinary skill will appreciate that some or all of the operations may be executed in a different order, be combined or omitted, or be executed in parallel. The system provides recommendations, referred to as smart recommendations, for the filtering to be used based on multiple factors, including the user profile, the user history, the application displaying the list, the type of item being searched, metadata about the item (e.g., creation date), etc.

As the user scrolls down, the system presents a message if there are other filtering options that may be more useful to the user, other than the default filtering option.

To determine the smart filtering recommendations, at operation 402, the system determines the presentation environment with the data that may be useful to select different filters. The environment presentation may include one or more of user profile information, user history information, user activity on the application presenting the list of items, the type of items being presented, the size of the list (e.g., depending on the size of the list, the scrolling step for S2 mode may be adjusted), search parameters entered by the user (if any), metadata about the items in the list (e.g., creation date, modification date, creator, file folder, document type, identified people within a photograph, identified people within a recording, etc.).

In some example environments, the environment data is used as input to the ML model 404, and the ML model 404 generates a list 406 of possible filters, where the list 406 also includes one or more values for each filter (e.g., filtered by date, week, or month). More details about the ML model 404 are presented below with reference to FIG. 5.

At operation 408, the system identifies the possible filters for presentation to the user. Additionally, at operation 410, a default filter is selected from the filter list 406 (e.g., default filter for browsing photographs is browsing by month, default filter for scrolling in a large document is scrolling by chapter).

FIG. 5 illustrates the training and use of a machine-learning model for selecting filters, according to some example embodiments. In some example embodiments, a machine-learning (ML) model 404 is utilized to determine filters for scrolling to be recommended to a user based on the information about the user and the data being scrolled.

Machine Learning (ML) is an application that provides computer systems the ability to perform tasks, without explicitly being programmed, by making inferences based on patterns found in the analysis of data. Machine learning explores the study and construction of algorithms, also referred to herein as tools, that may learn from existing data and make predictions about new data. Such machine-learning algorithms operate by building an ML model 404 from example training data 512 in order to make data-driven predictions or decisions expressed as outputs or assessments 520. Although example embodiments are presented with respect to a few machine-learning tools, the principles presented herein may be applied to other machine-learning tools.

There are two common modes for ML: supervised ML and unsupervised ML. Supervised ML uses prior knowledge (e.g., examples that correlate inputs to outputs or outcomes) to learn the relationships between the inputs and the outputs. The goal of supervised ML is to learn a function that, given some training data, best approximates the relationship between the training inputs and outputs so that the ML model can implement the same relationships when given inputs to generate the corresponding outputs. Unsupervised ML is the training of an ML algorithm using information that is neither classified nor labeled, and allowing the algorithm to act on that information without guidance. Unsupervised ML is useful in exploratory analysis because it can automatically identify structure in data.

Common tasks for supervised ML are classification problems and regression problems. Classification problems, also referred to as categorization problems, aim at classifying items into one of several category values (for example, is this object an apple or an orange?). Regression algorithms aim at quantifying some items (for example, by providing a score to the value of some input). Some examples of commonly used supervised-ML algorithms are Logistic Regression (LR), Naive-Bayes, Random Forest (RF), neural networks (NN), deep neural networks (DNN), matrix factorization, and Support Vector Machines (SVM).

Some common tasks for unsupervised ML include clustering, representation learning, and density estimation. Some examples of commonly used unsupervised-ML algorithms are K-means clustering, principal component analysis, and autoencoders.

In some embodiments, example ML model 404 provide a list of possible filters and possible values for the filters. The training data 512 comprises examples of values for the features 502. In some example embodiments, the training data 512 comprises labeled data with examples of values for the features 502 and labels indicating the outcome, such as past scrolling activities by users and when users stopped scrolling (e.g., considered a positive outcome).

The machine-learning algorithms utilize the training data 512 to find correlations among identified features 502 that affect the outcome. A feature 502 is an individual measurable property of a phenomenon being observed. The concept of a feature is related to that of an explanatory variable used in statistical techniques such as linear regression. Choosing informative, discriminating, and independent features is important for effective operation of ML in pattern recognition, classification, and regression. Features 502 may be of different types, such as numeric features, strings, and graphs.

In one example embodiment, the features 502 may be of different types and may include one or more of user profile information 503, user history information 504 (e.g., activities of the user in the online service), device information 505, S2 filters 506 already defined, type of items in the list 507, item metadata 508, application 509 presenting the list being scrolled, et cetera. During training 514, the ML program, also referred to as ML algorithm or ML tool, analyzes the training data 512 based on identified features 502 and configuration parameters defined for the training. The result of the training 514 is the ML model 404 that is capable of taking inputs to produce assessments.

Training an ML algorithm involves analyzing large amounts of data (e.g., from several gigabytes to a terabyte or more) in order to find data correlations. The ML algorithms utilize the training data 512 to find correlations among the identified features 502 that affect the outcome or assessment 520. In some example embodiments, the training data 512 includes labeled data, which is known data for one or more identified features 502 and one or more outcomes.

The ML algorithms usually explore many possible functions and parameters before finding what the ML algorithms identify to be the best correlations within the data; therefore, training may make use of large amounts of computing resources and time.

When the ML model 404 is used to perform an assessment, new data 518 is provided as an input to the ML model 404, and the ML model 404 generates the assessment 520 as output. For example, when a user is scrolling through a list, the ML model 404 provides a list of filters.

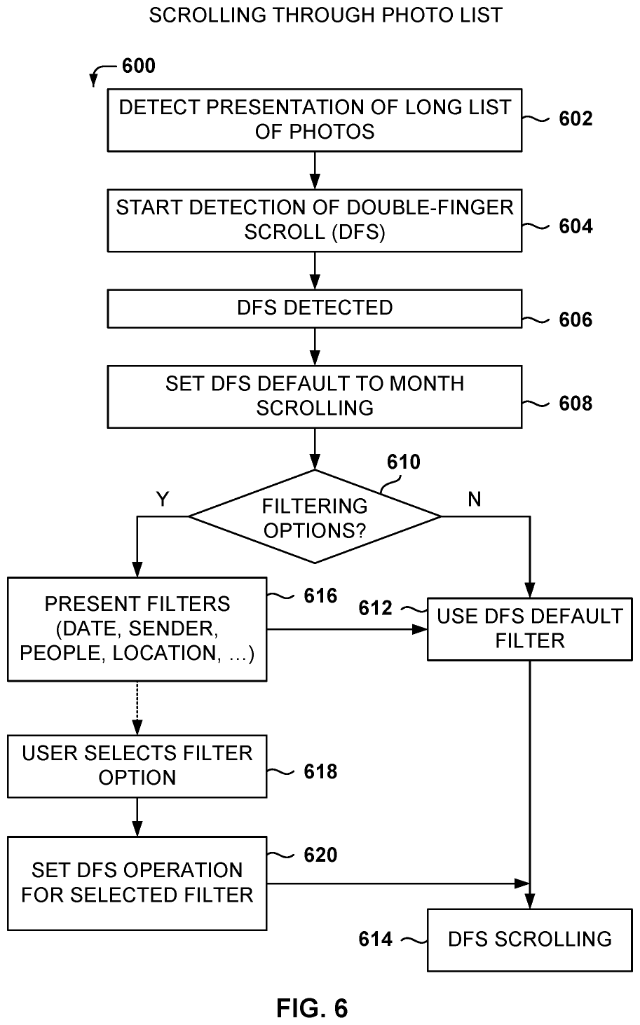

FIG. 6 is the flowchart of a method 600 for implementing multimodal scrolling in a photo searching application, according to some example embodiments. While the various operations in this flowchart are presented and described sequentially, one of ordinary skill will appreciate that some or all of the operations may be executed in a different order, be combined or omitted, or be executed in parallel.

At operation 602, the presentation of a long list of photos is detected. For example, when the user is searching through a photo-gallery application. The system starts detecting, at operation 604, for the DFS by the user.

At operation 606, the DFS is detected, and at operation 608, the default scrolling method for DFS is set (e.g., scroll by month).

From operation 608, the method 600 flows to operation 610 where a check is made to determine if additional filtering options are available, besides the default monthly scroll. If no additional filtering options are available, the default DFS mode is selected at operation 612, and DFS scrolling is performed at operation 614.

If additional filtering options are available, at operation 616, additional filters are presented (e.g., by date, by week, by year, by sender, by creator, by location, by people in the photographs, by tag, etc.).

If the user selects one of the filter options 618, at operation 620, the DFS operation is changed to use the selected filter.

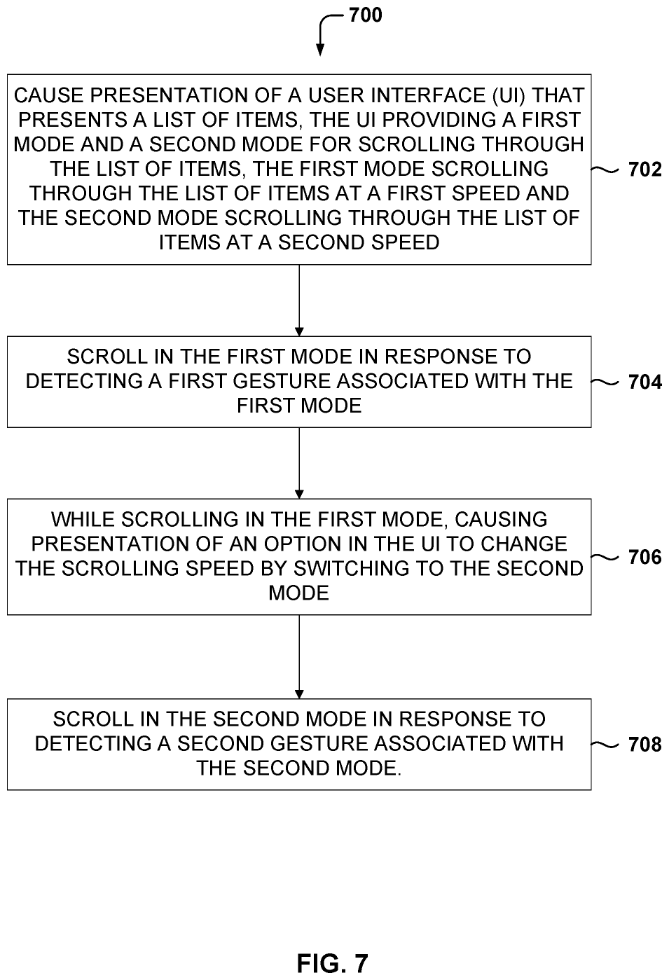

FIG. 7 is a flowchart of a method 700 for providing multimodal scrolling in a computer user interface, according to some example embodiments. While the various operations in this flowchart are presented and described sequentially, one of ordinary skill will appreciate that some or all of the operations may be executed in a different order, be combined or omitted, or be executed in parallel.

Operation 702 is for causing presentation, by a processor, of a user interface (UI) that presents a list of items. The UI provides a first mode and a second mode for scrolling through the list of items. The first mode scrolls through the list of items at a first speed and the second mode scrolls through the list of items at a second speed. The first speed and the second speed are different speeds.

From operation 702, the method 700 flows to operation 704 for scrolling, by the processor, in the first mode in response to detecting a first gesture associated with the first mode. From operation 704, the method 700 flows to operation 706 for, while scrolling in the first mode, causing presentation, by the processor, of an option in the UI to change the scrolling speed by switching to the second mode.

From operation 706, the method 700 flows to operation 708 for scrolling, by the processor, in the second mode in response to detecting a second gesture associated with the second mode. In one example, presentation of the option to change the scrolling speed further comprises: providing one or more filtering options for selecting the second speed associated with the second mode, receiving a selection of a filter value in the UI, and updating the second speed based on the selected filter value.

In one example, the filter options are selected from a group consisting of scrolling one item at a time, by initial letter of a contact name, by company in a contacts list, by date, by week, by month, by year, by sheet on a spreadsheet, by chapter in a document, by section in a document, by page in a document, by section on a newspaper or website, by sender, by recipient, by creator, by people detected in photos, by subject, and by client.

In one example, the method 700 further comprises determining, by a machine-learning (ML) model, the one or more filtering options based on information about the user and the list of items, the ML model being trained with training data with values associated with a plurality of features. In one example, the plurality of features are selected from a group consisting of user profile information, user history information, information about a device presenting the UI, previously used filters, category of items in the list of items, metadata on the list of items, and application presenting the UI.

In one example, the method 700 further comprises providing a first-gesture listener program for detecting the first gesture, and providing a second-gesture listener program for detecting the second gesture.

In one example, the first gesture is one-finger scrolling on a touchscreen or a touchpad, wherein the second gesture is two-finger scrolling on a touchscreen or a touchpad.

In one example, the first gesture and the second gesture are selected from a group comprising one-finger scrolling on a touchscreen or a touchpad, two-finger scrolling on the touchscreen or the touchpad turning a wheel on a mouse, turning a wheel on the mouse while pressing a keyboard key, a hand gesture in front of an image capturing device, and moving an electronic pen on a display.

In one example, the list of items is a list of photographs, wherein the first mode scrolls linearly down the list, wherein the second mode scrolls by month of creation of the photo.

In one example, the method 700 further comprises defining a default second speed for the second mode, wherein the default second speed is used until the user selects a different second speed. Another general aspect is for a system that includes a memory comprising instructions and one or more computer processors. The instructions, when executed by the one or more computer processors, cause the one or more computer processors to perform operations comprising: cause presentation of a UI that presents a list of items, the UI providing a first mode and a second mode for scrolling through the list of items, the first mode scrolling through the list of items at a first speed and the second mode scrolling through the list of items at a second speed; scrolling in the first mode in response to detecting a first gesture associated with the first mode; while scrolling in the first mode, causing presentation of an option in the UI to change the scrolling speed by switching to the second mode; and scrolling in the second mode in response to detecting a second gesture associated with the second mode.

In yet another general aspect, a machine-readable storage medium (e.g., a non-transitory storage medium) includes instructions that, when executed by a machine, cause the machine to perform operations comprising: cause presentation of a UI that presents a list of items, the UI providing a first mode and a second mode for scrolling through the list of items, the first mode scrolling through the list of items at a first speed and the second mode scrolling through the list of items at a second speed; scrolling in the first mode in response to detecting a first gesture associated with the first mode; while scrolling in the first mode, causing presentation of an option in the UI to change the scrolling speed by switching to the second mode; and scrolling in the second mode in response to detecting a second gesture associated with the second mode.

In view of the disclosure above, various examples are set forth below. It should be noted that one or more features of an example, taken in isolation or combination, should be considered within the disclosure of this application.

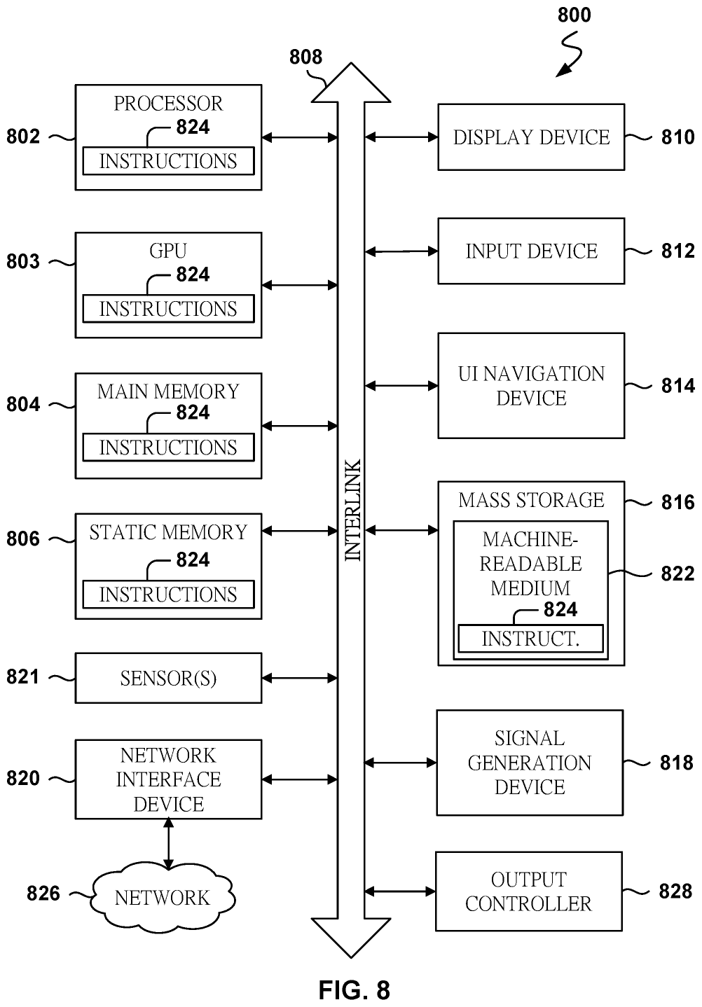

FIG. 8 is a block diagram illustrating an example of a machine 800 upon or by which one or more example process embodiments described herein may be implemented or controlled. In alternative embodiments, the machine 800 may operate as a standalone device or may be connected (e.g., networked) to other machines. In a networked deployment, the machine 800 may operate in the capacity of a server machine, a client machine, or both in server-client network environments. In an example, the machine 800 may act as a peer machine in a peer-to-peer (P2P) (or other distributed) network environment. Further, while only a single machine 800 is illustrated, the term “machine” shall also be taken to include any collection of machines that individually or jointly execute a set (or multiple sets) of instructions to perform any one or more of the methodologies discussed herein, such as via cloud computing, software as a service (SaaS), or other computer cluster configurations.

Examples, as described herein, may include, or may operate by, logic, a number of components, or mechanisms. Circuitry is a collection of circuits implemented in tangible entities that include hardware (e.g., simple circuits, gates, logic). Circuitry membership may be flexible over time and underlying hardware variability. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits) including a computer-readable medium physically modified (e.g., magnetically, electrically, by moveable placement of invariant massed particles) to encode instructions of the specific operation. In connecting the physical components, the underlying electrical properties of a hardware constituent are changed (for example, from an insulator to a conductor or vice versa). The instructions enable embedded hardware (e.g., the execution units or a loading mechanism) to create members of the circuitry in hardware via the variable connections to carry out portions of the specific operation when in operation. Accordingly, the computer-readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry, at a different time.

The machine (e.g., computer system) 800 may include a hardware processor 802 (e.g., a central processing unit (CPU), a hardware processor core, or any combination thereof), a graphics processing unit (GPU) 803, a main memory 804, and a static memory 806, some or all of which may communicate with each other via an interlink 808 (e.g., bus). The machine 800 may further include a display device 810, an alphanumeric input device 812 (e.g., a keyboard), and a user interface (UI) navigation device 814 (e.g., a mouse). In an example, the display device 810, alphanumeric input device 812, and UI navigation device 814 may be a touch screen display. The machine 800 may additionally include a mass storage device (e.g., drive unit) 816, a signal generation device 818 (e.g., a speaker), a network interface device 820, and one or more sensors 821, such as a Global Positioning System (GPS) sensor, compass, accelerometer, or another sensor. The machine 800 may include an output controller 828, such as a serial (e.g., universal serial bus (USB)), parallel, or other wired or wireless (e.g., infrared (IR), near field communication (NFC)) connection to communicate with or control one or more peripheral devices (e.g., a printer, card reader).

The mass storage device 816 may include a machine-readable medium 822 on which is stored one or more sets of data structures or instructions 824 (e.g., software) embodying or utilized by any one or more of the techniques or functions described herein. The instructions 824 may also reside, completely or at least partially, within the main memory 804, within the static memory 806, within the hardware processor 802, or within the GPU 803 during execution thereof by the machine 800. In an example, one or any combination of the hardware processor 802, the GPU 803, the main memory 804, the static memory 806, or the mass storage device 816 may constitute machine-readable media.

While the machine-readable medium 822 is illustrated as a single medium, the term “machine-readable medium” may include a single medium, or multiple media, (e.g., a centralized or distributed database, and/or associated caches and servers) configured to store the one or more instructions 824.

The term “machine-readable medium” may include any medium that is capable of storing, encoding, or carrying instructions 824 for execution by the machine 800 and that cause the machine 800 to perform any one or more of the techniques of the present disclosure, or that is capable of storing, encoding, or carrying data structures used by or associated with such instructions 824. Non-limiting machine-readable medium examples may include solid-state memories, and optical and magnetic media. In an example, a massed machine-readable medium comprises a machine-readable medium 822 with a plurality of particles having invariant (e.g., rest) mass. Accordingly, massed machine-readable media are not transitory propagating signals. Specific examples of massed machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 824 may further be transmitted or received over a communications network 826 using a transmission medium via the network interface device 820.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

1. A system comprising:
a memory comprising instructions; and
one or more computer processors, wherein the instructions, when executed by the one or more computer processors, cause the system to perform operations comprising:
causing presentation of a user interface (UI) that presents a list of items, the UI providing a first mode and a second mode for scrolling through the list of items, the first mode scrolling through the list of items at a first speed and the second mode scrolling through the list of items at a second speed;
scrolling in the first mode in response to detecting a first gesture associated with the first mode;
while scrolling in the first mode, causing presentation of an option in the UI to change the scrolling speed by switching to the second mode; and
scrolling in the second mode in response to detecting a second gesture associated with the second mode.

2. The system as recited in claim 1, wherein presentation of the option to change the scrolling speed further comprises:
providing one or more filtering options for selecting the second speed associated with the second mode;
receiving a selection of a filter value in the UI; and
updating the second speed based on the selected filter value.

3. The system as recited in claim 2, wherein the filter options are selected from a group consisting of scrolling one item at a time, by initial letter of a contact name, by company in a contacts list, by date, by week, by month, by year, by sheet on a spreadsheet, by chapter in a document, by section in a document, by page in a document, by section on a newspaper or website, by sender, by recipient, by creator, by people detected in photos, by subject, and by client.

4. The system as recited in claim 2, wherein the instructions further cause the one or more computer processors to perform operations comprising:
determining, by a machine-learning (ML) model, the one or more filtering options based on information about a user and the list of items, the ML model being trained with training data with values associated with a plurality of features.

5. The system as recited in claim 4, wherein the plurality of features are selected from a group consisting of user profile information, user history information, information about a device presenting the UI, previously used filters, category of items in the list of items, metadata on the list of items, and application presenting the UI.

6. A computer-implemented method comprising:
causing presentation, by a processor, of a user interface (UI) that presents a list of items, the UI providing a first mode and a second mode for scrolling through the list of items, the first mode scrolling through the list of items at a first speed and the second mode scrolling through the list of items at a second speed;
scrolling, by the processor, in the first mode in response to detecting a first gesture associated with the first mode;
while scrolling in the first mode, causing presentation, by the processor, of an option in the UI to change the scrolling speed by switching to the second mode; and
scrolling, by the processor, in the second mode in response to detecting a second gesture associated with the second mode.

7. The method as recited in claim 6, wherein presentation of the option to change the scrolling speed further comprises:
providing one or more filtering options for selecting the second speed associated with the second mode;
receiving a selection of a filter value in the UI; and
updating the second speed based on the selected filter value.

8. The method as recited in claim 7, wherein the filter options are selected from a group consisting of scrolling one item at a time, by initial letter of a contact name, by company in a contacts list, by date, by week, by month, by year, by sheet on a spreadsheet, by chapter in a document, by section in a document, by page in a document, by section on a newspaper or website, by sender, by recipient, by creator, by people detected in photos, by subject, and by client.

9. The method as recited in claim 7, further comprising:
determining, by a machine-learning (ML) model, the one or more filtering options based on information about a user and the list of items, the ML model being trained with training data with values associated with a plurality of features.

10. The method as recited in claim 9, wherein the plurality of features are selected from a group consisting of user profile information, user history information, information about a device presenting the UI, previously used filters, category of items in the list of items, metadata on the list of items, and application presenting the UI.

11. The method as recited in claim 6, further comprising:
providing a first-gesture listener program for detecting the first gesture; and
providing a second-gesture listener program for detecting the second gesture.

12. The method as recited in claim 6, wherein the first gesture is one-finger scrolling on a touchscreen or a touchpad, wherein the second gesture is two-finger scrolling on a touchscreen or a touchpad.

13. The method as recited in claim 6, wherein the first gesture and the second gesture are selected from a group comprising one-finger scrolling on a touchscreen or a touchpad, two-finger scrolling on the touchscreen or the touchpad turning a wheel on a mouse, turning a wheel on the mouse while pressing a keyboard key, a hand gesture in front of an image capturing device, and moving an electronic pen on a display.

14. A system comprising means to perform any method of claim 6.

15. At least one machine-readable media including instructions that, when executed by a machine, cause the machine to perform any method of claim 6.
